(19) United States
(12) Patent Application Publication
(10) Pub. No.: US 2007/0245530 A1
(43) Pub. Date: Oct. 25, 2007

(54) Illuminated tongue

(75) Inventors: Mark F. Gray, Sterling Heights, MI (US); Paul M. Smith, Davison, MI (US); Richard J. Jodts, St. Clair, MI (US)

Correspondence Address: FOLEY AND LARDNER LLP;SUITE 500, 3000 K STREET NW, WASHINGTON, DC, 20007, US

(73) Assignee: TK HOLDINGS INC.

(21) Appl. No.: 11/730,924

(22) Filed: Apr. 4, 2007

Related U.S. Application Data
(60) Provisional application No. 60/744,482, filed on Apr. 7, 2006.

(51) Int. Cl. A44B 11/25; B60Q 3/02; B60R 22/00

(52) U.S. Cl. 24/633; 280/801.1; 362/483

(57) ABSTRACT

An occupant restraint system includes a belt, a tongue, and a buckle. The belt extends and retracts across a vehicle occupant to protect the occupant. The tongue is coupled to the belt. The tongue includes a striker portion and a tongue housing. The buckle includes a buckle housing and a latch nested therein. The latch is configured to attach the striker portion of the tongue inside the buckle housing. The tongue includes an illuminable portion configured to selectively exude light therefrom and/or a thermal source.

### CROSS-REFERENCE TO RELATED PATENT APPLICATIONS

this application claims priority to U.S. Provisional Application No. 60/744,482, filed Apr. 7, 2006, which is incorporated herein by reference in its entirety.

### BACKGROUND

This application generally relates to the field of occupant restraint systems having a tongue and buckle assembly. More particularly, this application relates to an occupant restraint system having an illuminable portion and/or thermal source integrated therein.

Occupant restraint systems for vehicles typically include a matable tongue and buckle assembly configured to secure the vehicle occupant to the seat 20 during rapid acceleration and deceleration. Tongues typically include a striker portion composed of a stamped chrome material and a housing composed of a hard plastic. Alternatively, the tongue housing may be composed of a deformable material to increase user comfort and reduce noise.

In vehicle interiors it may be difficult to locate the buckle and/or the tongue when they are in poorly lit areas of the vehicle interior. Some vehicles include a flashlight, overhead lighting or other external light sources to assist vehicle users in locating the tongue or buckle. Still, such external light sources can require multiple hands to simultaneously operate the light source and buckle the seat belt, which can be cumbersome for vehicle users.

Also since the striker portion of the tongue is generally composed of a metal it is thermally conductive. Upon reaching excessively cold or excessively warm temperatures the tongue may be uncomfortable for vehicle users to handle.

Therefore, it is desirable to incorporate a light source integrated in the tongue housing. It is also desirable, to include a thermal source which selectively heats or cools the striker portion of the tongue.

### SUMMARY

One exemplary embodiment relates to an occupant restraint system. The occupant restraint system comprises: a belt configured to extend and retract across a vehicle occupant; a tongue coupled to the belt, the tongue includes a striker portion and a tongue housing; and a buckle to receive the tongue. The buckle includes a buckle housing and a latch nested therein. The latch is configured to attach the striker portion of the tongue inside the buckle housing. The tongue includes an illuminable portion configured to selectively exude light therefrom.

Another exemplary embodiment relates to an occupant restraint system. The occupant restraint system comprises: a belt configured to extend and retract across a vehicle occupant; a tongue coupled to the belt, the tongue includes a striker portion and a tongue housing; and a buckle to receive the tongue. The buckle includes a buckle housing and a latch nested therein. The latch is configured to attach the striker portion of the tongue inside the buckle housing. The tongue includes a thermal source configured to alter the temperature of the tongue.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a schematic depiction of a vehicle having an occupant restraint system according to an exemplary embodiment.

FIG. 2 is a perspective view of a tongue and buckle of an occupant restraint system according to an exemplary embodiment.

FIG. 3 is a top plan view of the tongue according to an exemplary embodiment.

FIG. 4 is a side view of the tongue and power source according to an exemplary embodiment.

FIG. 5 is a sectional view of a tongue housing according to an embodiment in which a membrane switch is illustrated.

FIG. 6 is a schematic view of a tongue and power source according to another embodiment.

FIG. 7 is a side view of a tongue and thermal source according to another exemplary embodiment.

FIG. 8 is a top plan view of a tongue according to an exemplary embodiment in which a thermal source and thermocouple is shown.

### DETAILED DESCRIPTION

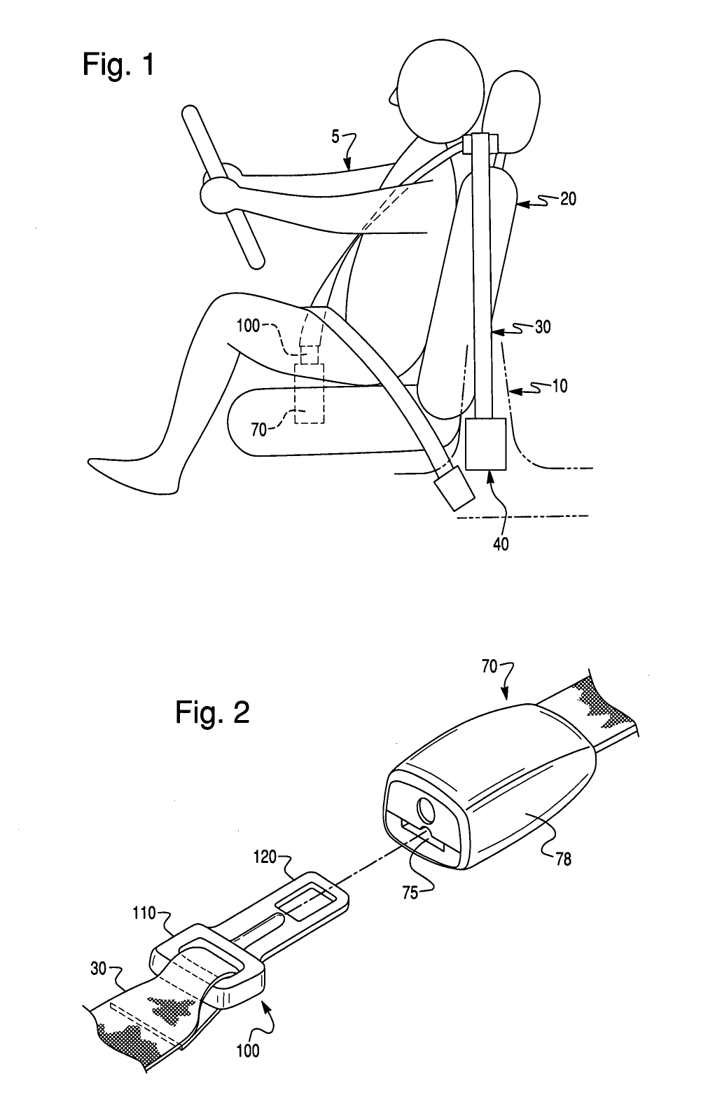

Referring to FIG. 1, illustrated therein is a vehicle occupant restraint system for usage in a passenger vehicle 10. The occupant restraint system consists of a belt 30, tongue 100 and matable buckle 70, as shown in FIG. 2. Upon attaching the tongue 100 to the buckle 70, the belt 30 is latched across the vehicle occupant 5 to secure the occupant 5 to the vehicle seat 20. Incorporated within the occupant restraint system is an illuminable portion 140 configured to exude light therefrom, thereby providing light to vehicle users when buckling and unbuckling the occupant restraint system.

The belt 30 is configured to extend and retract across the vehicle occupant 5 when seated. The belt 30 is sometimes referred to as a “webbing.” The belt 30 is typically composed of a nylon material which is threaded through a tongue housing 110. The tongue 100 slides with respect to the belt 30 when in the unbuckled position. The belt 30 is connected to a belt retractor assembly 40 which is configured to guide the belt 30 between winding and unwinding. The retractor assembly 40 includes a plurality of springs configured to pretension the belt 30 in the winding direction.

The buckle 70 is fixed with respect to the vehicle 10. In one exemplary embodiment, the buckle 70 is anchored to the vehicle frame so that the seat belt 30 is secured or locked in place when it is attached to the buckle 70. The buckle 70 includes a buckle housing 78. The buckle housing 78 may be composed of, for example, a hard plastic, and/or foam. The buckle housing 78 protects a latch 75 incorporated therein and to prevent unwanted disengagement of the latch 75. The latch 75 is configured to secure a striker portion 120 of the tongue 100 therein. The latch 75 is further configured to selectively release the tongue 100 either manually or automatically. One example of an automatically releasable buckle 70 and latch 75 is disclosed U.S. Pat. No. 5,359,756, which is commonly assigned and herein incorporated by reference.

The tongue 100 includes a striker portion 120 and a housing portion. The tongue housing 110 may be composed of a hard plastic, soft foam, and/or rubber material configured to deform upon applying pressure. The striker portion 120 is located on the perimeter of the tongue 100. The striker portion 120 is configured to attach or hook into the latch 75 of the buckle 70 upon engagement, thereby securing the tongue 100 and belt 30 to the buckle 70. The striker portion 120 may be composed of chromatic steel, or any other suitable material.

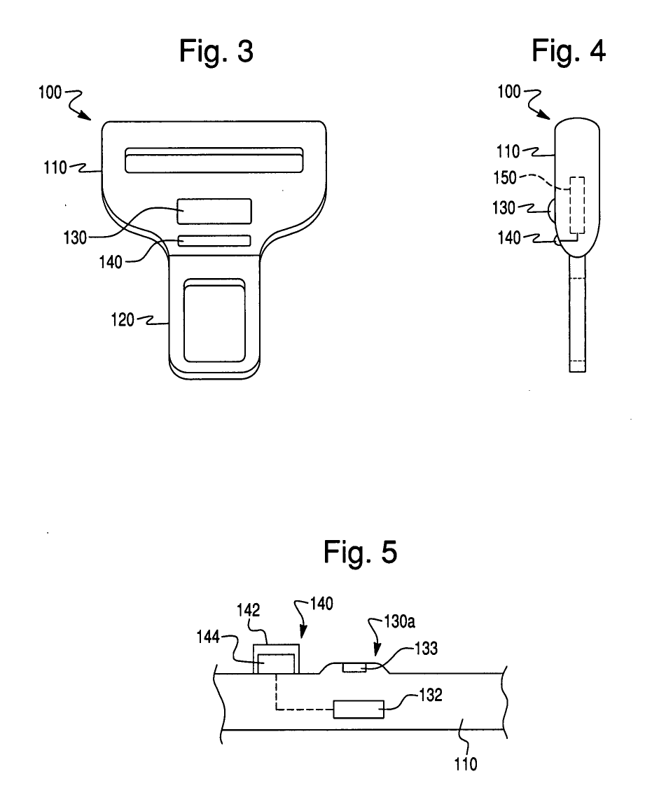

Incorporated within the tongue housing 110 is an illuminable portion 140 configured to exude light therefrom, as shown in FIGS. 3-5. The illuminable portion 140 includes at least one light source 144 which is actuated by a switch 130. The switch 130 may be any switch 130 known within the art including but not limited to a circuit breaker, mercury switch, wafer switch, DIP switch, surface mount switch, reed switch, toggle switch, push-button switch, touch-activated switch and/or microswitch.

In one exemplary embodiment shown in FIG. 5, the switch 130 is a membrane switch 130a which includes an interior and exterior portion. The exterior portion of the membrane switch 130a is configured to interact with the vehicle users' hands and/or fingers. The interior portion includes a surface 133 having a pattern and/or protrusion configured to complete an electrical circuit connecting the power source 150 and the light source 144. The surface may be, for example, a touch plate 133 composed of an electrically conductive material such as copper. The membrane switch 130a is deformable (or movable) with respect to the tongue housing 110 and upon moving the touch plate 133 with respect to the tongue housing 110 the touch plate 133 interacts with electrical connectors 132 mounted within the tongue housing 110 to complete the electrical circuit and power the light source 144. One example of a membrane switch 130a is disclosed in U.S. Pat. No. 6,797,906, which is herein incorporated by reference in its entirety.

The illuminable portion 140 includes at least one light source 144 and a translucent cover 142 configured to encase the light source(s) 144, such as shown in FIG. 5. When the vehicle occupant handles the tongue 100, the illuminable portion 140 exudes light in a direction outward with respect to the tongue housing 110. The light source(s) 144 may be any number of light sources which include but are not limited to incandescent light bulbs, electroluminescent lamps, LEDs, and/or fiber optics. In one exemplary embodiment, the belt 30 includes a series of fiber optic wires configured to transmit light from a source to the illuminable portion 140 of the occupant restraint system. The fiber optic wires are configured to be flexible with the belt 30 as it winds and unwinds. An example of fiber optic wiring is disclosed in U.S. Pat. No. 6,854,869, which is herein incorporated by reference in its entirety. The translucent cover 142 may be any number of colors to suit customer demands and/or safety concerns. For example, in a vehicle having a dark color scheme (e.g., black and charcoal) the translucent cover 142 may be configured to be of a color having strong contrast with respect to the vehicle interior such as red or green. The cover 142 is composed of a hard plastic or comparable material.

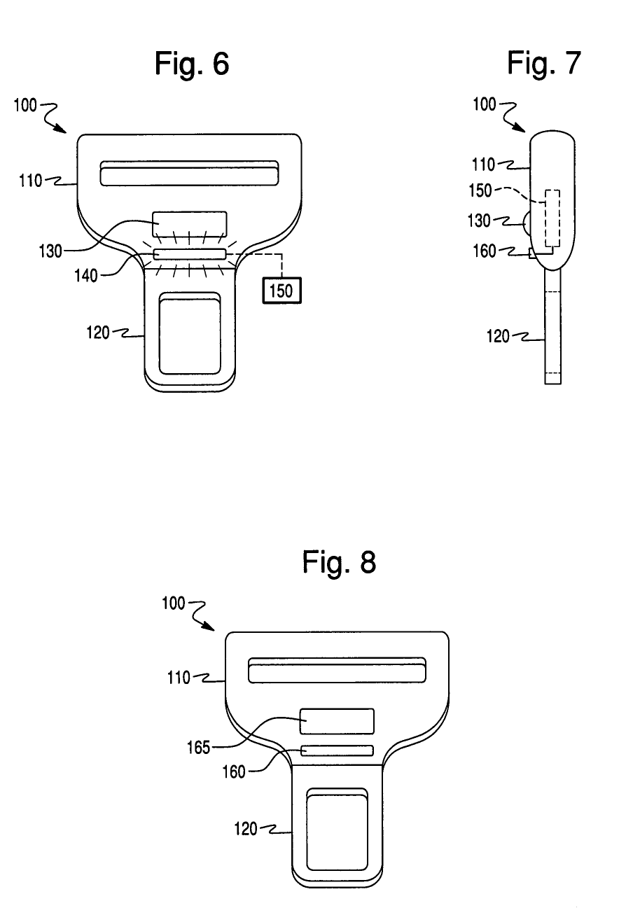

The illuminable portion 140 is electrically powered by a power source 150. The power source 150 may be incorporated within the tongue housing 110 (FIG. 4) or it may be located remotely (FIG. 6) with respect to the tongue housing 110 (e.g., within the retractor assembly 40). In another exemplary embodiment, the power source 150 is remotely located with respect to the tongue 100 and electrical wires are configured to extend throughout the seat belt 30 to provide power to the illuminable portion 140 of the occupant restraint system. In one exemplary embodiment, the illuminable portion 140 is coupled to the vehicle's power source 150. In another exemplary embodiment the power source 150 is a battery. The battery may be any battery known within the filed such as, for example, an alkaline, NiMH, or lithium battery. In one exemplary embodiment, the power source 150 is rechargeable.

In another exemplary embodiment shown in FIG. 7, the tongue 100 includes a thermal source 160 to increase and/or decrease the temperature of the tongue 100 (including the striker portion 120). In one exemplary embodiment, thermal source 160 is actuated by a switch 130. The switch 130 may be any switch 130 known within the art including but not limited to a circuit breaker, mercury switch, wafer switch, DIP switch, surface mount switch, reed switch, toggle switch, push-button switch, and/or microswitch. In one exemplary embodiment, the thermal source 160 is actuated by a membrane switch 130a as described above.

In another exemplary embodiment shown in FIG. 8, the tongue 100 includes a thermocouple configured to measure the temperature of the tongue 100 and/or the ambient temperature. Upon measuring a temperature in excess of a predetermined threshold the thermal source 160 may provide heat—acting as a heat source—or remove heat—acting as a heat sump—from the tongue 100. For example, when operating the vehicle in locations such as Phoenix, Ariz. in the summer months, the thermal source 160 is configured to cool the tongue 100 and striker portion 120 upon sensing an ambient temperature greater than 90° F. Likewise, when operating the vehicle in locations such as Juneau, Ak. the thermal source 160 is configured to heat the tongue 100 and striker portion 120 when the ambient temperature falls below 0° F. The thermal source 160 is coupled to an electrical power source 150. The power source 150 may be located remotely or incorporated within the tongue housing 110. The power source 150 may include any type of power source 150. In one exemplary embodiment, the thermal source 160 is coupled to the vehicle's power source 150. In another exemplary embodiment, the power source 150 is a battery. The battery may be any battery known within the filed such as, for example, an alkaline, NiMH or lithium battery. In one exemplary embodiment, the power source 150 is rechargeable.

In one exemplary embodiment, the occupant restraint system includes a switch 130 located remotely with respect to the tongue housing 110. For example, the switch 130 may be incorporated into the latch and striker assembly of the vehicle door (not shown) so that the illuminable portion 140 and/or thermal source 160 are configured to automatically activate upon opening the vehicle door. In another exemplary embodiment, the switch 130 is located within the door locking mechanism so that the illuminable portion 140 and/or thermal source 160 are configured to automatically activate upon unlocking the vehicle door.

While the exemplary embodiments illustrated in the FIGS. and described above are presently preferred, it should be understood that these embodiments are offered by way of example only. For example, the teachings herein can be applied to any latching assembly and is not limited to a vehicle occupant restraint system.

It will be recognized that the embodiments described above may be combined. For example, an occupant restrain system may include a tongue with both a thermal source and an illuminable portion, which may be activated by the same or different switches.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An occupant restraint system, comprising:
a belt configured to extend and retract across a vehicle occupant;
a tongue coupled to the belt, the tongue includes a striker portion and a tongue housing; and
a buckle to receive the tongue, the buckle including a buckle housing and a latch nested therein, wherein the latch is configured to attach the striker portion of the tongue inside the buckle housing, and
wherein the tongue includes an illuminable portion configured to selectively exude light therefrom.

2. The occupant restraint system of claim 1, further comprising a switch to selectively operate a light source of the illuminable portion.

3. The occupant restraint system of claim 2, wherein the switch comprises a deformable membrane switch.

4. The occupant restraint system of claim 3, wherein the membrane switch comprises a touch plate configured to interact with an electrical connector mounted in the tongue housing.

5. The occupant restraint system of claim 1, further comprising a power source to provide power to operate the illuminable portion.

6. The occupant restraint system of claim 5, wherein the power source is positioned within the tongue.

7. The occupant restraint system of claim 5, wherein the power source is remotely located with respect to the tongue.

8. The occupant restraint system of claim 1, wherein the illuminable portion includes a light source and a translucent cover encasing the light source.

9. The occupant restraint system of claim 1, wherein the illuminable portion comprises a LED light.

10. The occupant restraint system of claim 1, wherein the illuminable portion is positioned in the tongue housing.

11. An occupant restraint system, comprising:
a belt configured to extend and retract across a vehicle occupant;
a tongue coupled to the belt, the tongue includes a striker portion and a tongue housing; and
a buckle to receive the tongue, the buckle including a buckle housing and a latch nested therein, wherein the latch is configured to attach the striker portion of the tongue inside the buckle housing, and
wherein the tongue includes a thermal source configured to alter the temperature of the tongue.

12. The occupant restraint system of claim 11, wherein the thermal source is positioned within the tongue housing.

13. The occupant restraint system of claim 11, further comprising a switch to selectively operate the thermal source.

14. The occupant restraint system of claim 13, wherein the switch comprises a deformable membrane switch.

15. The occupant restraint system of claim 14, wherein the membrane switch comprises a touch plate configured to interact with an electrical connector mounted in the tongue housing.

16. The occupant restraint system of claim 11, further comprising a power source to provide power to operate the thermal source.

17. The occupant restraint system of claim 16, wherein the power source is positioned within the tongue.

18. The occupant restraint system of claim 17, wherein the power source is remotely located with respect to the tongue.

19. The occupant restraint system of claim 11, further comprising a thermocouple to measure a temperature of the tongue and/or ambient temperature.
